(19) United States
(12) Patent Application Publication
(10) Pub. No.: US 2023/0245554 A1
(43) Pub. Date: Aug. 3, 2023

(54) METHOD AND COMPUTER PROGRAM FOR CHARACTERIZING FUTURE TRAJECTORIES OF TRAFFIC PARTICIPANTS

(71) Applicant: ZF Friedrichshafen AG, Friedrichshafen (DE)

(72) Inventors: Firas MUALLA, Sulzbach (DE); Georg SCHNEIDER, Urbar (DE); Nils MURZYN, Saarbrücken (DE); Vijay PARSI, Saarbrücken (DE)

(73) Assignee: ZF Friedrichshafen AG, Friedrichshafen (DE)

(21) Appl. No.: 18/164,434

(22) Filed: Feb. 3, 2023

(30) Foreign Application Priority Data
Feb. 3, 2022 (DE) 10 2022 201 127.9

(51) Int. Cl. G08G 1/01

(52) U.S. Cl. CPC G08G 1/0129; G08G 1/0112

(57) ABSTRACT

A method for characterizing future trajectories of traffic participants includes obtaining trajectory histories of traffic participants and environment features in a current traffic scenario as input, determining an embedding of trajectories and/or environment features relating to a traffic participant in a first features space for each traffic participant, mapping the image section of the embedding onto a second features space comprising a first number of characteristics, which each characterize the future trajectories for these traffic participants; a list, the length of which is the same as the first number, and the entries of which each indicate probabilities for the occurrence of one of the future trajectories with the respective characteristics; predicting trajectories for these traffic participants, and determining whether the trajectory predictions are based on different characteristics or are instances of the same characteristics.

### CROSS-REFERENCE TO RELATED APPLICATION

This application claims priority to German Application No. DE 10 2022 201 127.9, filed on Feb. 3, 2022, the entirety of which is hereby fully incorporated by reference herein.

### TECHNICAL FIELD

This disclosure relates to a method and a computer program for characterizing future trajectories of traffic participants.

### BACKGROUND

In the framework of AD/ADAS applications, but also in the field of industry 4.0 and collaborative human-robot interactions, a purely sensorial detection of the environment is insufficient. Instead, the temporal prediction of the further development of a dynamic scenario with all of its discrete interactors, e.g. people, vehicles, bicyclists, is becoming increasingly more important with regard to automated vehicles being able to make intelligent decisions, for example. Not only are the interactions of all of the interactors, e.g. traffic participants, among themselves important, but also the interactions thereof with their immediate environment, e.g. the traffic space and/or infrastructure, are of significant importance.

In order to be able to ensure that a scenario prediction is reliable and accurate, all of the explicit, implicit, regionally specific and event-specific rules and information must be taken into account and drawn on for temporal predictions. The German patent application DE 10 2020 210 379.8 discloses a hybrid scenario representation that models the interactions between stationary and dynamic objects and/or information.

The German patent application DE 10 2021 203 440.3 discloses a modelling of the interactions between traffic participants comprising automated driving systems over the entire traffic space and over a predefined time in the past by combining the histories of the traffic participants with all of the stationary and dynamic components of the scenario. This is then used to predict the trajectories/behaviors of all traffic participants for a specific time in the future.

Further prior art regarding the modelling of interactions is disclosed, by way of example, in Gao et al.: VectorNet: Encoding HD Maps and Agent Dynamics from Vectorized Representation, Computer Vision and Pattern Recognition 2020, arXiv:2005.04259 and in Zhao et al.: Multi-Agent Tensor Fusion for Contextual Trajectory Prediction, Proceedings of the IEEE/CVF Conference on Computer Vision and Pattern Recognition

(pp. 12126-12134).

### SUMMARY

In that individual trajectory histories are decoded onto numerous possible predicted trajectories, numerous possible futures are calculated, i.e. a one-to-many mapping is obtained, in which multiple statistical modes are presented. The one-to-many mapping makes it possible to depict the history of a traffic participant or road user in a specific environment onto numerous future predictions or numerous modes. By way of example, the environment can comprise a T-intersection. A passenger automobile approaches this T-intersection. The various modes include continuing in a straight line, turning left, or turning right.

Without defining a mode, it is not clear a priori whether two of the modes that are obtained are two different modes or two different instances of one mode when predicting the future movement of a road user. This means that it is also unclear whether or not an averaging may take place during training.

The uncertainty of the dividing lines between different modes impacts not only the reliability of the learning process, but also the assessment of the quality of the results. An averaging of the outputs when the inputs are identical within a correctly defined mode would then actually make sense.

Furthermore, there is no clear definition of a mode per se. This can also impact the user experience, the training and troubleshooting process, and the interpretations of the results.

Another problem is that there is normally a set number of modes, which is not known a priori, however.

Moreover, the multiple mode learning process may be unreliable. The output mode closest to a reference trajectory, i.e. the ground truth, is taken into account for the backpropagation during the training process. It becomes problematic in the case where the closest mode was another mode that has already been trained for and was simply selected because it was closer to the ground truth than some other random output that has not yet been experienced. As a result, a familiar mode is disregarded, simply in order to discover another mode.

One fundamental object of the present disclosure is to determine how an inter-mode averaging can be prevented in a one-to-many mapping, and how the interpretability of familiar modes and the reliability of the learning process can be improved through this mapping.

The subject matter of the present disclosure achieves this object in that a mode is identified in a second feature space, corresponding to a latent representation. The second feature space represents a characteristic that can be interpreted in an output space, i.e. the space of the future trajectories or trajectory predictions of the traffic agents. This enables interpretation of the modes. Furthermore, the user, developer or expert knowledge can be involved in the definition of what distinguishes the two modes. In another configuration, the characteristic is obtained from the data, using an adaptive loss function. This loss causes the acquired model, e.g. an artificial neural network, to map out a ground truth trajectory on a specific characteristic, or to deviate therefrom.

The distance between the ground truth and the output closest to the ground truth is not minimized during the training process, as is normally the case. Instead, the distance between the ground truth and that output, the latent representation of which is closest to the latent representation of the ground truth, is minimized. This prevents an averaging of the outputs between the modes, a so-called inter-mode averaging.

This same function can also be used for the generation of all modes. This means that there is a function, the parameters of which, but not their inputs, are independent of the modes, e.g. an artificial neural network, the parameters of which are independent of the modes. This function accepts two inputs: in addition to the normal inputs, i.e. the histories of all of the road users and the depictions of the scenarios, as disclosed in the prior art specified in the introduction, a latent depiction, i.e. the characteristic. This makes it possible to generate a variable number of modes for each input. The network is trained to generate an output that satisfies a characteristic. The second features space is strongly regularized.

One aspect of the present disclosure relates to a method for characterizing future trajectories of traffic participants. The method comprises the steps:
obtaining
   trajectory histories of traffic participants, comprising positions of the traffic participants over time, measured using traffic participant sensors, and/or simulated with driving dynamics and/or movement models, and/or extracted from map data, and
   environment features of a current traffic scenario as input;
determining an embedding of trajectories and/or environment features relating to a traffic participant in a first features space for each traffic participant;
mapping the image section of the embedding onto a second features space comprising
   a first number of characteristics, which each characterize the future trajectories for these traffic participants;
   a list, the length of which is the same as the first number, and the entries of which each indicate probabilities for the occurrence of one of the future trajectories with the respective characteristics;
predicting trajectories for these traffic participants;
determining whether the trajectory predictions are based on different characteristics or are instances of the same characteristics.

Another aspect of the present disclosure relates to a computer program for characterizing future trajectories of traffic participants. The computer program comprises commands with which a hardware platform in a remote system, a driver assistance system, or an autonomous driving system, executes the steps of a method according to any of the preceding claims, when the computer program is executed on the hardware platform.

The commands in the computer program according to the present disclosure comprise computer instructions, source code or object code written in assembly language, an object-oriented programming language, e.g. C++, or in a procedural programming language, e.g. C. The computer program is an application program that is hardware-independent according to one aspect, provided, for example, via a data medium or a data medium signal by means of software over-the-air programming (OTA programming).

Advantageous embodiments can be derived from the definitions, the claims, the drawings, and the descriptions of preferred exemplary embodiments.

Traffic participants comprise interactors in scenarios in an environment, e.g. in scenarios in a traffic space. Traffic participants are people, for example, such as pedestrians, vehicles, driving systems, and bicyclists. Driving systems comprise automated driving systems in vehicles ranging from automated to autonomous vehicles, road vehicles, people movers, shuttles, robots, and drones. Intelligent agents are also traffic participants, e.g. self-driving vehicles, robots, or intelligent infrastructure elements, e.g. intelligent lighting systems such as traffic lights, which communicate via wireless technologies, e.g. car-to-X communication, with other traffic participants.

Traffic participant sensors comprise cameras, radar sensors, lidar sensors, ultrasonic sensors, acoustic sensors, Car2X units, etc.

Driving dynamics and/or movement models use, e.g., the coordinates of the traffic participants, comprising positions and/or orientations over a specific timeframe, in order to generate trajectory histories. The driving dynamics or movement models are based on a Kalman filter, for example. The simulation is obtained using software, hardware, model, and/or vehicle-in-the-loop methods.

Map data comprise data from realtime and/or offline maps.

Environment features comprise houses, streets, in particular street layouts and/or physical conditions, signs, lane markings, vegetation, moving traffic participants, vehicles, pedestrians, and bicyclists. Stationary environment features are divided into two categories. Elements that basically do not change, or only change over long periods of time, but do not change their state in in the short-term, are referred to as rigid. In contrast, there are also elements that can change their states frequently, and are therefore state-changing. The latter category includes, e.g., traffic lights or variable traffic signs. Dynamic environment features are moving traffic participants in a traffic scenario, and comprise their positions and/or orientations.

Each traffic participant can be identified in the first features space via coordinates. The inputs, i.e. the trajectory histories and environment features, are obtained in the form of a tensor, for example.

The embedding represents information regarding the traffic participant, also referred to as agent-centric information, which is obtained by combining the history of the traffic participant in question, the traffic scenario, and the histories of the other traffic participants. A separate embedding can be obtained for each traffic participant. According to one aspect of the present disclosure, the embedding is obtained by means of a function that can be learned, e.g. in an artificial neural network. The embedding can be a tensorial value.

The second features space is the characteristic features space, the elements of which identify a trajectory prediction and/or a reference trajectory through a characteristic. The characteristic characterizes the trajectory prediction and/or reference trajectory. The second features space can therefore be interpreted in the framework of the trajectory predictions for the traffic participants. The features that characterize the respective future trajectories for these traffic participants are elements of a tensor according to one aspect of the present disclosure, and form the first number of characteristics. The list, the length of which is the same as the first number, and the entries of which each indicate probabilities for the occurrence of one of the future trajectories with the respective characteristics, i.e. the probability of the respective characteristic, is a probability vector according to one aspect of the present disclosure, the length of which is the same as the first number.

According to another aspect of the present disclosure, the method comprises the following steps:
determining a second number of residual characteristics from the first number of characteristics, the probability of which is greater than a first threshold value;
inputting pairs of data from the second number, comprising in each case the embedding and one of the residual characteristics, in a first machine learning model that has been or is trained on the basis of training data comprising the trajectory predictions and reference trajectories, to infer trajectory predictions with the given residual characteristics for these traffic participants;
outputting the trajectory predictions inferred with the machine learning model.

The first number is greater than the maximum number of modes. The second number of residual characteristics, a function of the embedding, is the number of modes exceeding a minimum residual probability, which is the first threshold value. By way of example, for a residual probability of 0.001, modes with a probability of less than 0.1% are ignored. The residual probability is a configuration parameter and can be set according to various criteria, including the ASIL (Automotive Safety Integrity Level) for the respective application. For each characteristic, the corresponding probability of which is greater than the residual characteristic, the embedding and this characteristic are mapped using the first machine learning model, e.g. an artificial neural network, onto a trajectory prediction. According to one aspect, the first machine learning model is used with the same set of parameters for all modes.

A machine learning model corresponds to a function that can be learned.

According to another aspect, the second features space comprises
predefined features with predefined feature ranges;
predefined features with feature ranges that can be learned;
features that can be learned
   or a combination of these features. The predefined features comprise, e.g.
the length of a trajectory;
spatial distribution of waypoints on a trajectory;
orientation of a trajectory;
Fourier descriptors of a trajectory;
environment features of the respective traffic scenario
   or a combination thereof. In the case of a combination, a characteristic is a list of features, e.g. a vector, comprising the individual features.

The above features can be based on expert knowledge.

The length of the trajectory is expressed through an average speed according to one aspect. The average speed corresponds to the mean value for the first derivatives of the trajectory.

The spatial distribution of the points on the trajectory is expressed through an average acceleration according to one aspect. The average acceleration corresponds to the second derivatives of the trajectory.

The orientation of the trajectory is expressed through an orientation bin up to a specific point in the trajectory according to one aspect of the present disclosure. This is the angle of the vector formed by the first point of the trajectory and the determined point of the same trajectory. The reference for the measurement of this angle can either be the orientation of the traffic participant or the current direction of movement of the traffic participant. A configuration example is the angle of the vector defined by the first and last point of the trajectory.

The Fourier descriptor is a scaling and orientation variation representation of closed contours. There are also variations that take open contours into account. The low-frequency features represent a rough characterization of the shape of the trajectory.

In another configuration, features from traffic scenarios can be drawn on, i.e. not only features of the trajectory, e.g. whether the movement of the traffic participant, represented by the trajectory, takes place on a street or a sidewalk. A stereotypical behavior in a typical traffic infrastructure can be depicted in this manner. One example thereof is the behavior when approaching a traffic light, taking into account the current color of the light and the local customs. It may be common practice in some places to react to a change from green to red with a brief acceleration, for example. In one version of the proposed solution, the characteristics of the modes can be learned for each region or country.

The second features space can be formed from the above features or some of these features. One example of a simple second features space is the space spanned by the features of the orientations bin, the average speed, and the average acceleration. The first machine learning model generates a trajectory for an embedding, e.g. a combined depiction of the history of the traffic participant in question, the histories of other road users, and a depiction of the traffic scenario and a latent vector (45, 2, 4) in this second features space, which has an angle of ca. 45° to the orientation of the traffic participant in question or its direction of movement. The average difference between two successive points in this trajectory is approximately 2 meters, wherein for purposes of simplicity, recordings are made at one frame per second. The average difference in the differences is approximately 4 meters/second. In this example, the feature orientation bin, average speed, and average acceleration are predefined. The features range for these fixed features can either be predefined or learned. Otherwise, the features are automatically learned from the data.

In another configuration, an arbitrary combination of the three aforementioned cases can be taken into consideration. By way of example, some features can be learned, some can be determined with feature ranges that can be learned, and some can be determined with fixed feature ranges.

According to another aspect, the image range for the embedding is mapped onto the second features space by means of a second machine learning model that has been or is trained to determine the second features space on the basis of training data comprising the trajectory predictions and reference trajectories, wherein the second machine learning model
has been or is trained with predefined feature ranges in the case of predefined features to determine the probabilities of the occurrence of one of the future trajectories with the respective features;
has been or is trained on the basis of training data in the case of predefined features with feature ranges that can be learned to also determine cluster centers in the second features space;
is trained on the basis of training data by means of regularizations in the case of features that can be learned to also learn the features.

The second machine learning model is an artificial neural network, for example, that has a narrow passage, e.g. a bottleneck structure or a pooling layer.

In this case, the term “additional” in predefined features with feature ranges that can be learned means that probabilities are also learned and that in this case, the case of predefined features with predefined feature ranges is included.

In the case of features that can be learned, the term “additional” means that the case of predefined features with predefined feature ranges and the case of predefined features with feature ranges that can be learned are included.

In the case of predefined features with predefined feature ranges, the characteristic tensor is a permanent reference table, which can also be defined implicitly via bins in each feature. The output of the second machine learning model is the probability vector. An example thereof is the aforementioned features space comprising the orientation bin, average speed, and average acceleration, wherein defined bins are predefined in each of the three features.

In the case of predefined features with feature ranges that can be learned, the characteristic and probability are tensor outputs of the second machine learning model. One example thereof is the aforementioned features space comprising the orientation bin, average speed, and average acceleration. The features do not contain predefined bins, however. Instead, the cluster centers of the characteristics in these features space are learned from training data.

In the case of features that can be learned, the characteristic and probability are tensor outputs of the second machine learning model. The features are not predefined, and instead are learned.

According to another aspect of the present disclosure, the trajectory predictions and the reference predictions are mapped onto the second features space by means of a function, wherein the function
is a predefined computation graph in the case of predefined features with predefined feature ranges, which calculates the features for a trajectory;
is a predefined computation graph in the case of predefined features with feature ranges that can be learned, and the cluster centers of the characteristics are learned in the second features space from training data;
is a third machine learning model in the case of features that can be learned, in which the features have been or are learned on the basis of training data, wherein a trajectory prediction and reference trajectory are assigned to different modes if a distance from the trajectory prediction to the reference prediction exceeds a second threshold value.

The definitions of the characteristic features are encapsulated in this function.

In the case of a predefined computation graph, the function calculates the orientation bin, average speed, and average acceleration for a trajectory, for example. This corresponds to a classification problem with the first number of classifications. In this regard, the classification information is not used in the bins. According to another aspect of the present disclosure, the classification relationships are taken into account in each feature by means of ordinal regression. The problem is approached therefore as an N_{F} ordinal regression problem with N_{B} ranges, where N_{F} is the number of features in the second features space and N_{B} is the number of bins in each feature.

The third machine learning model learns the feature ranges and features that can be learned.

According to another aspect of the present disclosure, a reference trajectory is mapped onto the second features space by means of the function described above. In a training forwards path,
the reference characteristic is determined from the first number of characteristics that exhibit a minimal distance to the mapping of the reference trajectory;
the trajectory predictions are output that are obtained from the input of the embedding and the previously determined residual feature in the first machine learning model.

The reference trajectory is therefore described by means of the characteristics of the second features space. The second machine learning model maps the first features space, comprising the histories of all of the traffic participants and the information regarding the traffic scenarios, onto the second features space. In contrast, the function, e.g. the third machine learning model, maps the trajectory predictions and reference trajectories onto the second features space. In accordance with the present disclosure, only the reference characteristic that is closest to the mapping of the reference trajectory is used for generating a trajectory prediction. In other words, a single output is generated on a training sample for each iteration.

The distance is a clearance, e.g. L1-norm, L2-norm, p-norm.

According to another aspect of the present disclosure, a trajectory prediction and a reference prediction are mapped onto the second features space by means of the function described above. In the case of predefined features with predefined feature ranges,
a first distance from the trajectory prediction to the reference prediction; and
a second distance from a predefined reference characteristic, which is at a minimal distance to the mapping of the reference trajectory, to the mapping of the trajectory prediction
   are determined in a training backwards path, and a loss function comprising the first and the second distance is minimized.

This results in a trajectory prediction that is as close as possible to the reference trajectory, which also has a characteristic that is as close as possible to the defined residual characteristic.

According to another aspect of the present disclosure, various terms in the loss function are weighted differently.

According to another aspect of the present disclosure, a trajectory prediction and a reference prediction are each mapped onto the second features space by means of the function described above. In the case of predefined features with feature ranges that can be learned,
a first distance from the trajectory prediction to the reference prediction;
a second distance from a reference characteristic, which is at a minimal distance to the mapping of the reference trajectory, to the mapping of the reference trajectory;
a third distance from the mapping of the trajectory prediction to the mapping of the reference trajectory; and
a first regularization term, with which the learning of the reference characteristic from the mapping of the reference trajectory is regularized, and which ensures that the respective distances from the remaining characteristics to the mapping of the reference trajectory are relatively large,
   are determined in a training backwards path, and a loss function that comprises the first, second and third distance, and the first regularization term is minimized.

In this case, the entries in the characteristic tensor are also learned and the deviation from the reference trajectories characteristic is therefore also backpropagated, but with derivatives with regard to the characteristic and the output trajectory.

In another configuration, the expert knowledge regarding possible ranges of the features can be incorporated in the first regularization term. By way of example, the condition that the pairs of distances must exceed a given minimum threshold value in each dimension could be enforced.

According to another aspect of the present disclosure, the function in the case of features that can be learned that maps the trajectory predictions and reference predictions on the second features space is learned in a training backwards path of the third machine learning model through minimizing an adaptive loss function such that in the case where the first distance from the trajectory prediction to the reference prediction falls below the second threshold value, the function maps the reference prediction onto the reference characteristic.

The adaptive loss function causes the function to map the mapping of the reference trajectory onto the same reference characteristic when the reference characteristic works well, or onto another characteristic if this is not the case. In the latter case, the same training sample of another characteristic can be selected in the next attempt. This prevents a mode averaging.

The other characteristic is selected randomly in one aspect of the present disclosure. The distribution from which this other characteristic is selected can be the uniform distribution. This can also be the distribution of probabilities, in particular if the backpropagation through the function first begins after a few epochs.

According to another aspect of the present disclosure, the adaptive loss function comprises a second regularization term, with which the parameters of the function are regularized. At the start of the training, the weightings of the function are random. The parameters of the function should be regularized to ensure that the function maps similar output trajectories onto similar characteristics.

The backpropagation of the adaptive loss function through the third machine learning model can also start after a few epochs of the training in order to stabilize the training. At the same time, the backpropagation of the second regularization term should start with the first training epoch, because the smoothness of the third machine learning model is a desired property, which contributes to the stabilization of the training from the start.

The first regularization term can be similar to the first regularization term for predefined features that have feature ranges that can be learned in this case. In another configuration, it can be assumed that the lines of the characteristic tensor are singular vectors of a matrix derived from the second machine learning model. This is a stronger regularization term and has the advantage that each change in a characteristic also automatically changes the others, such that they are always orthogonal.

According to another aspect of the present disclosure, the respective loss function comprises at least one sparsity regularization term, also referred to as a sparsity regularizer. By way of example, the sparsity regularization term is the L1-norm for the probability vector. The loss function can also comprise a so-called negative log-likelihood term. The sparsity regularization term compels sparsity with regard to the number of modes.

According to another aspect of the present disclosure, the embedding takes place in the form of a multi-agent/scenario embedding, as follows:
encoding the environment features comprising trajectory histories;
encoding the traffic scenario information comprising rigid stationary environment features and state-changing stationary environment features;
consolidating the above encodings to form a hybrid scenario representation comprising at least one first layer comprising the rigid stationary environment features, a second layer comprising the state-changing stationary environment features, and a third layer comprising dynamic environment features comprising trajectory histories;
determining interactions between the stationary and dynamic environment features on the basis of the hybrid scenario representation, wherein a first tensor embedding generates the rigid stationary environment features, a second tensor embedding generates the state-changing stationary environment features, and a third tensor embedding generates the dynamic environment features, and the first, second and third tensor embeddings are consolidated to form a multi-agent/scenario tensor;
extracting the features of the multi-agent/scenario tensor for each traffic participant at the position corresponding to the coordinates of the traffic participant, merging these features with the third tensor embedding for the traffic participants, and generating the multi-agent/scenario embedding for each traffic participant and each traffic scenario.

The environment features are encoded by means of a recurrent neural network according to one aspect of the present disclosure, which identifies temporally encoded data in the trajectory histories. The traffic scenario data are encoded by means of a convolutional neural network.

Consolidating refers to spatial consolidation. By way of example, spatial coordinates for the traffic participants and/or environment features are depicted in pixels. Position data for the traffic participants and/or environment features are obtained from map data according to one aspect of the present disclosure. A map section is formed in which each pixel of the layer of the environment scenario representation corresponding to the map information is assigned a value. The values are based on discrete labels in the map, e.g. numeric codes for streets, sidewalks, dotted lines, double lines, etc. The rights of way based on traffic regulation data are shown next to the map. A line is drawn to the middle of each lane for this. There are additional lines to intersections, indicating all legal maneuvers. The consolidation takes place using an interaction tensor-pooling module according to one aspect of the present disclosure, which can comprise software and/or hardware components.

The hybrid scenario representation separates a scenario into numerous layers. A real scenario is depicted as a hybrid of stationary and dynamic information. The scenario is an image, for example, that contains i pixels along the x-axis, and j pixels along the y-axis, in which the spatial coordinates for the traffic participants are depicted in pixels. The individual layers can also be shown as images, and are aligned spatially in relation to one another, e.g. the layers are placed on top of one another. The hybrid scenario representation can be imagined, for example, as a stack of digital photographs lying on top of one another, showing an intersection from a bird's-eye view. This stack of images is also combined with layers containing purely schematic information, e.g. simply represented as feature vectors.

The determination of interactions comprises predicting possible future interactions based on the eight layers of the hybrid scenario representation. Interactions relate to any interplay between stationary environment features, dynamic environment features, or between both stationary and dynamic environment features. In one exemplary scenario with interactions, a passenger automobile is located at an intersection. There is also a pedestrian at the intersection. Right of way is dictated by a traffic light. One interaction is the changing of the light. If, for example, the light is green for the passenger automobile, and red for the pedestrian, the further interactions that have been learned or are contained in the trajectory histories are that the pedestrian will remain in place, and the passenger automobile will enter the intersection. The interactions are determined by means of a convolutional neural network according to one aspect of the present disclosure.

The features of the multi-agent/scenario tensor are extracted for each traffic participant by means of an interaction vector extraction module, which can comprise software and/or hardware components.

According to another aspect of the present disclosure, the multi-agent/scenario embedding is decoded, and a trajectory prediction is generated for each traffic participant. The decoding takes place in a recurrent neural network according to one aspect of the present disclosure.

The present disclosure shall be explained below in reference to the drawings of exemplary embodiments.

### BRIEF DESCRIPTION OF THE DRAWINGS

FIG. 1 shows an exemplary embodiment of modes;

FIG. 2 shows an exemplary embodiment of an unstable learning process;

FIG. 3 shows an exemplary embodiment of a second features space according to various embodiments;

FIG. 4 shows an exemplary embodiment of an inference according to various embodiments;

FIG. 5 shows an exemplary embodiment of a training forwards path according to various embodiments;

FIG. 6 shows an exemplary embodiment of a training backwards path according to various embodiments in the case of predefined features with predefined feature ranges;

FIG. 7 shows an exemplary embodiment of a training backwards path according to various embodiments in the case of predefined features with feature ranges that can be learned; and

FIG. 8 shows an exemplary embodiment of a training backwards path according to various embodiments in the case of features that can be learned.

### DETAILED DESCRIPTION

The same reference symbols are used in the drawings for identical or functionally similar elements. For purposes of clarity, only the relevant elements are indicated in the individual drawings.

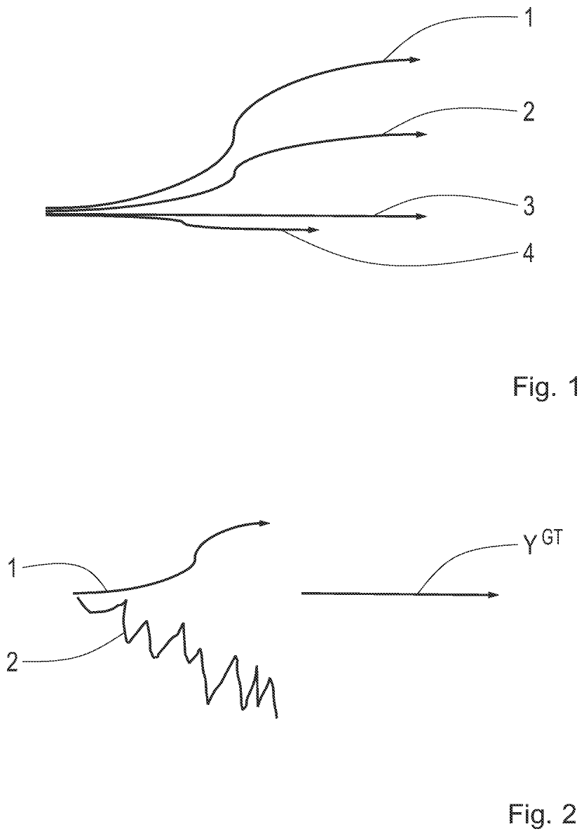

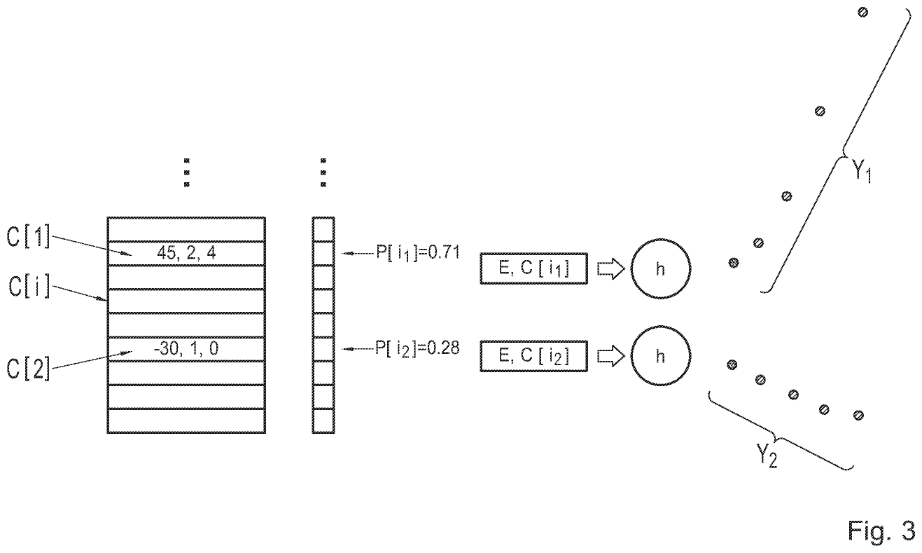

FIG. 1 shows the prediction of four future modes 1-4 for the movement of a traffic participant. A mode initially has no definition per se. This can affect a user experience, the training and trouble-shooting process and the interpretation of the results. Without a definition of the mode, it is not clear whether mode 3 and mode 3 are two different modes or two instances of one mode. It is also not clear whether or not averaging may take place during the training process. The method according to the present disclosure provides a solution for this in that it is determined during the execution thereof whether trajectory predictions Y are based on different characteristics or are instances of the same characteristic. These characteristics characterize the modes. According to the present disclosure, the modes 1-4 are identified through the characteristics C[i] of a second features space C; see FIG. 3, by way of example. As a result, the modes 1-4 can be interpreted according to the present disclosure. Furthermore, users and/or developers and/or expert knowledge can be involved in the definitions of what distinguishes two modes.

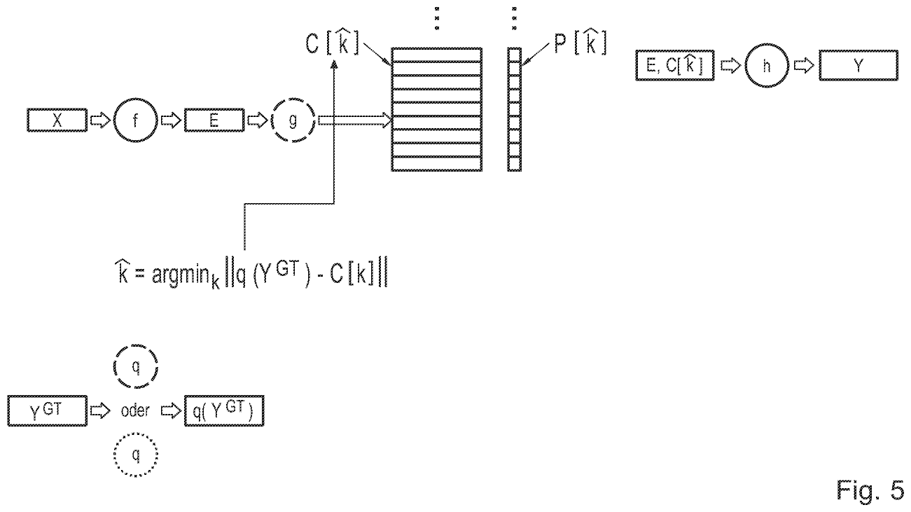

FIG. 2 shows how the multi-mode learning process is unstable in the prior art. A mode closest to a reference trajectory Y^{GT} is taken into account for the backpropagation during training in the known prior art. This can be problematic in the case in which the closest mode was already a mode 1 that has been learned thoroughly, and is simply selected because it is closer to the reference trajectory Y^{GT} than another mode 2 that has not yet been learned. The method according to the present disclosure provides a solution for this in that a distance is minimized between the reference trajectory Y^{GT} and that trajectory prediction Y, the latent representation of which, i.e. its characteristic, is closest to the latent representation of the reference trajectory Y^{GT}, see FIG. 5. This prevents an averaging of the modes.

In FIG. 3, the second features space C is spanned by three predefined features (θ_{∞}, s, a). θ_{∞} characterizes the orientation of a trajectory prediction Y, specifically the angle of the vector, for example, defined by the first and last points of the trajectory. s characterizes the duration of the trajectory prediction Y, or the average speed. a characterizes the spatial distribution of the points on the trajectory, or the average acceleration. The characteristic C[i₁]=(45, 2, 4) corresponds to a latent vector in the second features space C. For an embedding E and the latent vector (45, 2, 4), the first machine learning model h would then generate a trajectory prediction Y₁ that has an angle of ca. 45° to the orientation or direction of movement of the traffic participant in question, wherein the average difference between two successive points in this trajectory is approximately 2 meters, and the average difference in the differences is approximately 4 meters/second. For purposes of simplicity, a frame rate of 1.0 frames/second is assumed. For the embedding E and the latent vector C[i₂]=(−30, 1, 0), the first machine learning model h would then generate a trajectory prediction Y₂, accordingly.

As in the other drawings, the circle drawn with an unbroken line in FIG. 3 means that the respective circled function can be learned. The first machine learning model h is trained, and is therefore a function that can be learned.

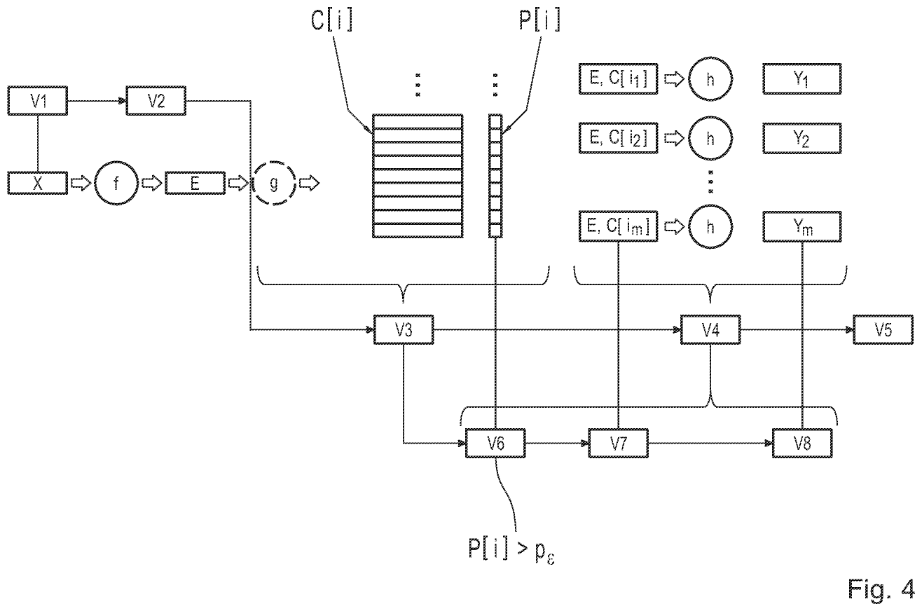

FIG. 4 shows the structure of the inference.

In a first step V1, the trajectory histories of all of the traffic participants and environment features in a current traffic scenario are obtained as inputs.

In a second step V2, for each traffic participant, an embedding E of trajectories and/or environment features relating to the traffic participant in question, comprising the trajectory histories of this traffic participant, is determined in the first features space by means of a function f that can be learned, e.g. in a fourth artificial neural network.

The embedding E may be a multi-agent/scenario embedding, for example, as disclosed in the German patent application DE 10 2021 203 440.3. The multi-agent/scenario embedding may be obtained through the following steps:
encoding the environment features comprising trajectory histories;
encoding the traffic scenario information comprising rigid stationary environment features and state-changing stationary environment features;
consolidating the above encodings to form a hybrid scenario representation comprising at least one first layer comprising the rigid stationary environment features, a second layer comprising the state-changing stationary environment features, and a third layer comprising dynamic environment features comprising trajectory histories;
determining interactions between the stationary and dynamic environment features on the basis of the hybrid scenario representation, wherein a first tensor embedding generates the rigid stationary environment features, a second tensor embedding generates the state-changing stationary environment features, and a third tensor embedding generates the dynamic environment features, and the first, second and third tensor embeddings are consolidated to form a multi-agent/scenario tensor;
extracting the features of the multi-agent/scenario tensor for each traffic participant at the position corresponding to the coordinates of the traffic participant, merging these features with the third tensor embedding for the traffic participants, and generating the multi-agent/scenario embedding for each traffic participant and each traffic scenario.

Alternatively, the embedding E can be generated with the VectorNets disclosed in Gao et al.: VectorNet: Encoding HD Maps and Agent Dynamics from Vectorized Representation, Computer Vision and Pattern Recognition 2020, arXiv:2005.04259, or similar approaches, or simply a convoluted neural network.

The method according to the present disclosure solves the problem of the stability of the learning process, comprising the mode averaging problem, and the problem relating to interpretability of learned modes.

In a third step V3, the image range of the embedding E is mapped onto the second features space C using a second machine learning model g. The second features space C comprises a first number N_{C} of characteristics C[i], each of which characterizes the future trajectories Y for the traffic participant in question, and a list, e.g. a vector, P, the length of which is equal to the first number N_{C}, and entries that are equal to the probabilities P[i] of the occurrence of one of the future trajectories Yᵢ with the respective characteristic C[i].

The method according to the present disclosure consequently enables the generation of a variable number of modes for each embedding E.

In a fourth step V4, the trajectories Y for the traffic participant in question are predicted, and in a fifth step V5, it is determined in a training process whether the trajectory predictions Y are based on different characteristics or are instances of the same characteristic.

A second number N_{M} of residual characteristics C[iₘ] is determined in a sixth step V6 from the first number N_{C} of the characteristics C[i], the probabilities of which are greater than a first threshold value p_{ε}. In a seventh step V7, the second number N_{M} of pairs of data, each comprising the embedding E and one of the residual characteristics C[iₘ] are input to the first machine learning model h. In an eighth step V8, the trajectory predictions inferred with the first machine learning model h are output for this embedding E. A variable number 1, . . . , N_{M} of modes is therefore generated for each embedding E. The first machine learning model h is trained such that a trajectory prediction Y_{1, . . . , m} is generated that satisfies a residual characteristic C[i_{1, . . . , m}] in each case.

As in the other drawings, the circle drawn with a broken line in FIG. 4 means that the circled function is a limited function that can be learned in each case. The second machine learning model g is an artificial neural network, for example, with a narrow passage, i.e. a so-called bottleneck structure.

FIG. 5 shows a training forward path. A reference trajectory Y^{GT} is mapped onto the second features space C by means of a function q. The reference characteristic C[\hat{k}] is determined from the first number N_{C} of characteristics C[i], in which the distance ∥q(Y^{GT})−C[k]∥ to the mapping q(Y^{GT}) of the reference trajectory Y^{GT} is minimal:

\hat{k}=argminₖ∥q(Y^{GT})−C[k]∥.

A trajectory prediction Y is output, resulting from the input of the embedding E and the previously determined reference characteristic C[k] in the first machine learning model h. Consequently, a single output is generated for each iteration on a training sample. The latent representation of the trajectory prediction Y determined in this manner is then at a minimal distance to the latent representation of the reference trajectory Y^{GT}.

As in the other drawings, the circle drawn with a dotted line in FIG. 5 means that the circled function is a limited predefined function. The function q is a fixed computing graph in the case of predefined features with feature ranges that are predefined or can be learned; with features that can be learned, the function q is a limited machine learning model, e.g. an artificial neural network with a bottleneck.

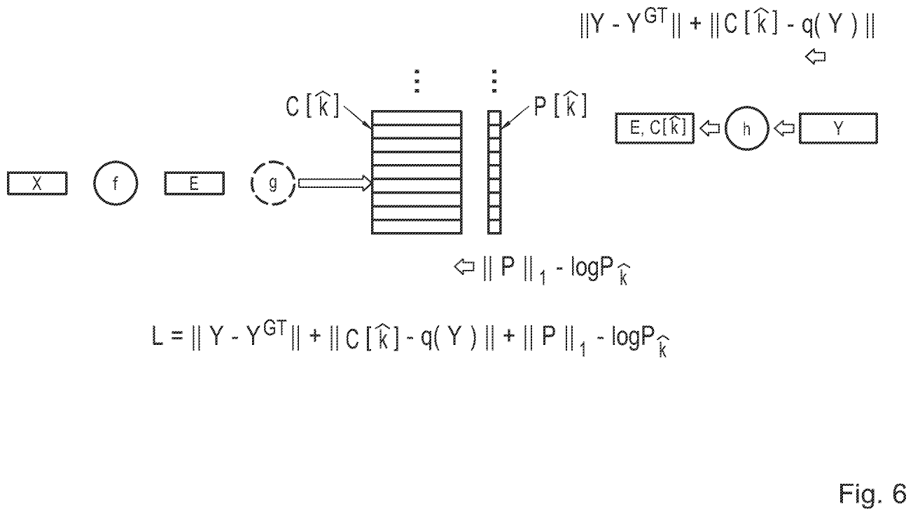

FIG. 6 shows a training backwards path in the case of predefined features with predefined feature ranges. A distance ∥Y−Y^{GT}∥ from the trajectory prediction Y to the reference trajectory Y^{GT} is determined.

A second distance ∥C[\hat{k}]−q(Y)∥ to the mapping q(Y) from a predefined reference characteristic C[\hat{k}], which is at a minimal distance k=argminₖ∥q(Y^{GT})−C[k]∥ to the mapping q(Y^{GT}) of the reference trajectory Y^{GT}, also determines the trajectory prediction Y. The characteristic q(Y) of the sought-after trajectory (Y) is therefore as close as possible to the predefined reference characteristic C[\hat{k}].

The following term is also minimized: ∥P∥₁−log P_{\hat{k}}.

P is the probability vector and can be obtained as an output of the second machine learning model g. The L1-norm for the probability vector is minimized by the term ∥P∥₁. This means that the second machine learning model g is taught such that the majority of the components of P are smaller than the first threshold value p_{E}, or equal to zero. As a result, few modes are generated.

−log Pₖ is the negative log-likelihood loss function, which maximizes the probability P[\hat{k}].

In this training backwards path, the loss function

L=∥Y−Y^{GT}∥+∥C[\hat{k}]−q(Y)∥+∥P∥₁−log P_{\hat{k}}

is then minimized.

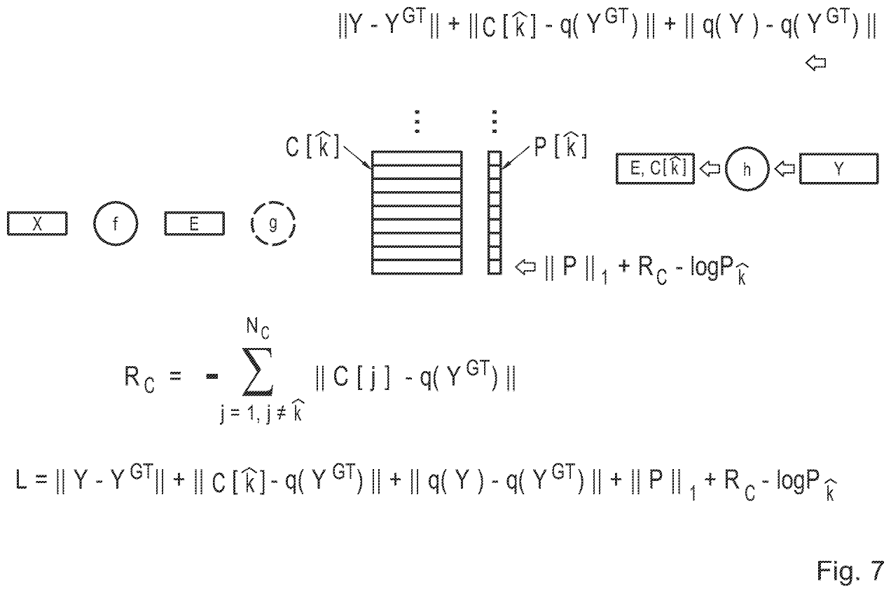

FIG. 7 shows a training backwards path in the case of predefined features with feature ranges that can be learned. The value of the reference characteristic C[\hat{k}] is no longer predefined, unlike in the case illustrated in FIG. 6, but instead must be learned. For this reason, a second distance ∥C[\hat{k}]−q(Y^{GT})∥ and third distance ∥q(Y)−q(Y^{GT})∥ are determined.

The second distance ∥C[\hat{k}]−q(Y^{GT})∥ is a distance from a reference characteristic C[\hat{k}] to the mapping q(Y^{GT}) of the reference trajectory Y^{GT}. The second distance describes a deviation from the ground truth characteristic with respect to the reference characteristic C[\hat{k}].

The third distance ∥q(Y)−q(Y^{GT})∥ is the distance from the mapping q(Y) of the trajectory prediction Y to the mapping q(Y^{GT}) of the reference trajectory Y^{GT} The third distance describes a deviation from the ground truth characteristic with respect to the trajectory prediction Y.

A regularization term

$${R}_{C} = - {\sum }_{j = 1 , j \neq \hat{k}}^{{N}_{C}} ‖ C [ j ] - q ( {Y}^{GT} ) ‖$$

is also determined, which regularizes that the reference characteristic C[\hat{k}] is learned from the mapping q(Y^{GT}) of the reference trajectory Y^{GT} and the respective distances (∥C[j]−q(Y^{GT}) ID from the other characteristics C[j] to the mapping q(Y^{GT}) of the reference trajectory Y^{GT} are relatively large. In another configuration, expert knowledge regarding possible ranges of the characteristics can be incorporated in R_{C}. By way of example, the condition that the paired distances in each dimension should exceed a predefined minimum threshold value can be enforced.

In this training backwards path, the loss function

L=∥Y−Y^{GT}∥+∥C[\hat{k}]−q(Y^{GT})∥+∥q(Y)−q(Y^{GT})∥+∥P∥₁+R_{C}−log P_{\hat{k}}

is then minimized.

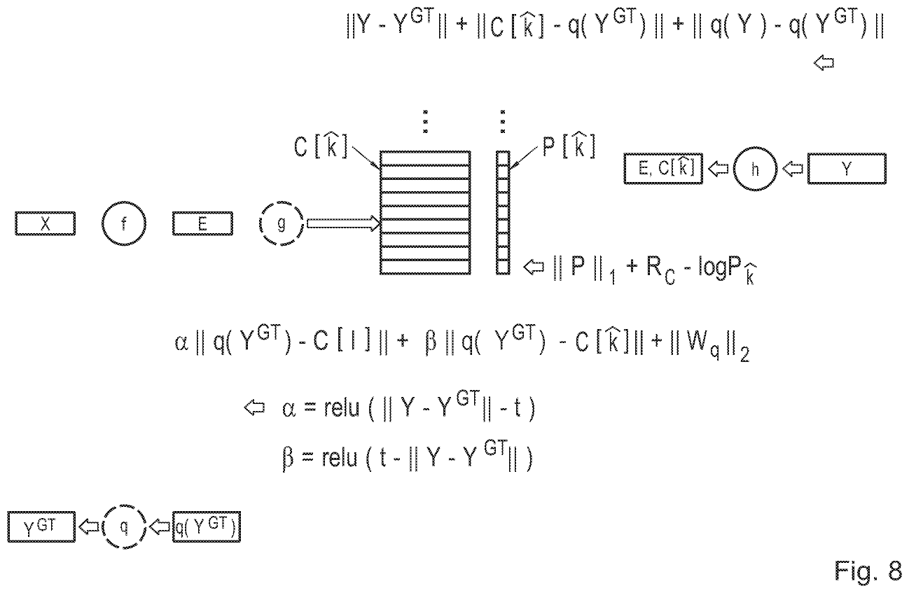

FIG. 8 shows a training backwards path in the case of features that can be learned. In this case, the function q is learned in a training backwards path for a third machine learning model through minimizing an adaptive loss function

Lₐ=α∥q(Y^{GT})−−C[l]∥+β∥q(Y^{GT})−C[\hat{k}]∥+R_{q}

such that in the case where the first distance (∥Y−Y^{GT}∥) from the trajectory prediction Y to the reference trajectory Y^{GT} falls below a second threshold value, the function q maps the reference trajectory Y^{GT} onto the reference characteristic C[k].

In this case, R_{q} is a second regularization term, R_{q}=∥W_{q}∥₂, which regularizes the parameter W=(w₁, . . . , w_{q}) for the function q. l≠\hat{k} is a number from the first number 0, 1, . . . , N_{C}−1.

The second threshold value can correspond to a specific deviation of a trajectory prediction Y from the reference trajectory Y^{GT}, in which Y and Y^{GT} are assigned two different modes.

The factor α can be defined as follows, for example: α≡relu(∥Y−Y^{GT}∥−t), in which re/u means “rectifier linear unit.” This means:

α=0⇔∥Y−Y^{GT}∥<t.

Accordingly, the factor β can be defined as β≡relu(t−∥Y−Y^{GT}∥) meaning

β=0⇔∥Y−Y^{GT}∥>t.

If α=0, then β is relatively large; if β=0, then α is relatively large. Therefore, for a specific trajectory prediction Y and its reference trajectory Y^{GT}, one of the two factors α or β is zero, while the other assumes a positive value.

The adaptive loss function Lₐ causes q to map q(Y^{GT}) onto the same latent characteristic C[\hat{k}] when C[\hat{k}] performs well (α is large and β=0, i.e. ∥Y−Y^{GT}∥ is small), or onto another C[l] if this is not the case (β is large and α=0). In the latter case, a different characteristic can be selected the next time that the training process is applied to the same training sample. In other words, another \hat{k} can be selected in the next forwards path, which could prevent the mode averaging. C[l] can be selected randomly. The distribution from which/is taken can be the uniform distribution. This can also be the distribution P (output from g), in particular if the reverse propagation by q begins after a few epochs (such that P-values are somewhat reasonable).

### REFERENCE SYMBOLS

1-4 modes
V1-V8 method steps
Y trajectory prediction
Y^{GT} reference trajectory
X input
E embedding
C second features space
s length of the trajectory
a spatial distribution of waypoints
θ orientation
C[i] characteristic
C[im] residual characteristic (inference)
c [\hat{k}] reference characteristic (training)
NC first number of characteristics
NM second number of residual characteristics
P list, vectors of probabilities
P[i] probabilities of the occurrence of the future trajectories Yi with the respective characteristics C[i]
pε first threshold value
t second threshold value
h first machine learning model
g second machine learning model
q function, implemented as either a predefined computation graph or a third machine learning model
f fourth machine learning model
W vector of parameters w1, . . . , wq for q
L loss function
La adaptive loss function
α, β factors
RC first regularization term
Rq second regularization term
∥ ∥ distance, distance measurement
∥ ∥₁ L1-Norm
∥ ∥₂ L1-Norm
relu rectifier linear unit

1. A method for characterizing future trajectories of traffic participants, comprising:
obtaining trajectory histories of a plurality of traffic participants and environment features of a current traffic scenario as inputs, wherein the trajectory histories of the plurality of traffic participants comprise positions of the plurality traffic participants over time, which are measured using traffic participant sensors, and/or simulated with driving dynamics and/or movement models, and/or extracted from map data;
determining an embedding of trajectories and/or environment features relating to the traffic participants in a first features space for each traffic participant;
mapping an image section of the embedding onto a second features space, wherein the second features space comprises:
a first number of characteristics, which each characterize the future trajectories for the plurality of traffic participants, and
a list having a length that is the same as the first number of characteristics, and having entries that each indicate probabilities for an occurrence of one of the future trajectories with the respective characteristics;
predicting trajectories for the plurality of traffic participants; and
determining whether the predicted trajectory are based on different characteristics or are instances of the same characteristics.

2. The method according to claim 1, comprising:
determining a second number of residual characteristics from the first number of characteristics, a probability of which is greater than a first threshold value;
inputting pairs of data from the second number comprising in each case the embedding and one of the residual characteristics in a first machine learning model that has been or is trained on a basis of training data comprising trajectory predictions and reference trajectories, to infer trajectory predictions with the given residual characteristics for the plurality of traffic participants;
outputting the trajectory predictions inferred with the machine learning model.

3. The method according to claim 1, wherein the second features space comprises at least one of:
predefined features with predefined feature ranges;
predefined features with feature ranges that can be learned; of
features that can be learned,

4. The method according to claim 3, wherein the predefined features comprise at least one of:
a length of a trajectory;
a spatial distribution of waypoints on a trajectory;
an orientation of a trajectory;
Fourier descriptors of a trajectory; or
environment features of the respective traffic scenario,
wherein a characteristic comprises a list of features comprising the respective individual features.

5. The method according to claim 1, further comprising mapping an image range of the embedding onto the second features space by a second machine learning model that is trained to determine the second features space on a basis of training data comprising the trajectory predictions and reference trajectories.

6. The method according to claim 5, wherein the second machine learning model is at least one of:
trained with predefined feature ranges in a case of predefined features to determine probabilities of the occurrence of one of the future trajectories with the respective features;
trained on a basis of training data in a case of predefined features with feature ranges that can be learned to also determine cluster centers in the second features space; and/or
trained on a basis of training data by means of regularizations in a case of features that can be learned to also learn the features.

7. The method according to claim 1, further comprising:
mapping the trajectory predictions and the reference predictions onto the second features space by a function, wherein the function is one of:
a predefined computation graph in a case of predefined features with predefined feature ranges, wherein the computation graph calculates the features for a trajectory;
a predefined computation graph in a case of predefined features with feature ranges that can be learned, and cluster centers of the characteristics are learned in the second features space from training data; or
a third machine learning model in a case of features that can be learned, in which the features have been or are learned on a basis of training data, wherein a trajectory prediction and reference trajectory are assigned to different modes if a distance from the trajectory prediction to the reference prediction exceeds a second threshold value.

8. The method according to claim 7, further comprising:
mapping a reference trajectory onto the second features space by the function;
determining the reference characteristic from a first number of characteristics that exhibit a minimal distance to the mapping of the reference trajectory; and
outputting the trajectory predictions that are obtained from the input of the embedding and a previously determined reference characteristic in the first machine learning model.

9. The method according to claim 7, further comprising:
mapping a trajectory prediction and a reference prediction onto the second features space by the function;
determining, in a case of predefined features with predefined feature ranges, a first distance from the trajectory prediction to the reference prediction; and
determining a second distance from a predefined reference characteristic, which is at a minimal distance to the mapping of the reference trajectory, to the mapping of the trajectory prediction,
wherein a loss function comprising the first distance and the second distance is minimized.

10. The method according claim 7, further comprising:
mapping a trajectory prediction and a reference trajectory onto the second features space by the function; and
determining, in a case of predefined features with feature ranges that are learned:
a first distance from the trajectory prediction to the reference prediction;
a second distance from a reference characteristic to the mapping of the reference trajectory;
a third distance from the mapping of the trajectory prediction to the mapping of the reference trajectory; and
a first regularization term, with which the learning of the reference characteristic from the mapping of the reference trajectory is regularized, and which ensures that the respective distances from the remaining characteristics to the mapping of the reference trajectory are relatively large,
wherein a loss function that comprises the first distance, the second distance, the third distance, and the first regularization term is minimized.

11. The method according to claim 7,
wherein, in a case of features that can be learned, the function is learned in a training backwards path in the third machine learning model through minimizing an adaptive loss function such that, in a case where the first distance from the trajectory prediction to the reference trajectory falls below the second threshold value, the function maps the reference trajectory onto the reference characteristic.

12. The method according to claim 11, wherein the adaptive loss function comprises a second regularization term, which regularizes parameters of the function.

13. The method according to claim 11, wherein a respective loss function comprises at least one term.

14. The method according to claim 1, wherein the embedding is a multi-agent/scenario embedding, and comprises:
encoding the environment features comprising trajectory histories;
encoding the traffic scenario information comprising rigid stationary environment features and state-changing stationary environment features;
consolidating the above encodings to form a hybrid scenario representation comprising at least one first layer comprising the rigid stationary environment features, a second layer comprising the state-changing stationary environment features, and a third layer comprising dynamic environment features comprising trajectory histories;
determining interactions between the stationary and dynamic environment features on a basis of the hybrid scenario representation, wherein a first tensor embedding generates the rigid stationary environment features, a second tensor embedding generates the state-changing stationary environment features, and a third tensor embedding generates the dynamic environment features, and the first, second and third tensor embeddings are consolidated to form a multi-agent/scenario tensor; and
extracting the features of the multi-agent/scenario tensor for each traffic participant at the position corresponding to the coordinates of the traffic participant, merging these features with the third tensor embedding for the traffic participants, and generating the multi-agent/scenario embedding for each traffic participant and each traffic scenario.

15. A non-transitory computer readable medium having stored therein a computer program that, when executed by a hardware platform in a remote system, causes the hardware platform to execute the method according to claim 1.
